(19) United States
(12) Patent Application Publication
(10) Pub. No.: US 2022/0395947 A1
(43) Pub. Date: Dec. 15, 2022

(54) SYSTEM FOR PROCESSING A WORKPIECE

(71) Applicant: Peddinghaus Corporation, Bradley, IL (US)

(72) Inventors: Nicholas Pickering, Chebanse, IL (US); Eric Simek, Wilmington, IL (US)

(21) Appl. No.: 17/777,562

(22) PCT Filed: Jan. 14, 2020
(86) PCT No.: PCT/US2020/013469

§ 371 Date: May 17, 2022

(51) Int. Cl. B23Q 3/157

(52) U.S. Cl. CPC B23Q 3/15713; B23K 10/00

(57) ABSTRACT

A system (40) is provided for processing a workpiece. The system (40) includes a support surface (48) for supporting a workpiece and includes an automatic tool changer (64) having a first tool storage bay (80) for removably storing a drill tool therein and having a second tool storage bay (80) for removably storing a plasma torch tool therein. The system (40) includes at least one drill spindle (60) movable with respect to a surface of a workpiece. The drill spindle (60) and the automatic tool changer (64) are movable relative to one another and configured to transfer between them a drill tool stored in the first tool storage bay (80) and a plasma torch tool stored in the second tool storage bay (80).

### TECHNICAL FIELD

This invention relates to a system for processing of a workpiece. Such processing may involve conveying and severing a length of stock (including, for example, a piece of structural steel) into one or more shorter length segments, cutting, drilling, milling, punching holes, cutting profiles with a torch, layout marking, etc. More particularly, one aspect of this invention relates to a processing system equipped with a drill spindle and tool changer configured to also hold a marking or cutting torch for performing a marking or cutting process.

### BACKGROUND OF THE INVENTION AND TECHNICAL PROBLEMS POSED BY THE PRIOR ART

Fabrication of a workpiece (such as, for example, a structural steel wide flange H-beam, angle, tube, channel, flat plate, etc.) may require layout marking, cutting, drilling, punching, and/or severing portions of the workpiece. Conventional systems or machines can perform one or more of these processing jobs or operations. For example, a machine can be used to drill holes in a workpiece while a separate machine can cut part of the workpiece with a cutting torch.

In one type of system, a workpiece is supported lengthwise on, and clamped to, a support surface in the form of a table or conveyor that is adjacent to a drill carriage which supports a drill spindle so that a drill mounted thereto can be moved to desired locations along the length of the workpiece, along the height of the workpiece, and toward or away from (i.e., normal to) a surface of the workpiece.

In some systems, the drill spindle can also be tilted (angled) in a plane that is perpendicular to the length of the workpiece support table and/or can be tilted (angled) in a plane that is parallel to the horizontal support surface of the workpiece support table.

In another type of system, the workpiece is moved through an assembly of tools (e.g., punches, drills, cutting torches, etc.) which are at fixed locations along the length of the system.

Workpieces in the form of structural beams may have to be provided in appropriate lengths for being erected in specific structures. Methods for creating one or more shorter segments or beams from a length of stock include severing the shorter segments from the length of stock with a cutting torch or with a shearing apparatus. When beams are erected in structures, the ends of the beams and/or other portions of the beams are typically connected together with bolts. The bolts are received in holes provided in the webs and flanges of the beams.

Conventional methods for providing the bolt holes in a beam include drilling the holes with one or more drill spindles, or punching the holes with one or more punch presses. For example, “web” punch presses may be used to provide holes in the beam web, and “flange” punch presses may be used to provide holes in the beam flanges. Such punch presses may have conventional designs well-known to those skilled in the art. Various designs are disclosed in U.S. Pat. Nos. 4,631,996, 3,722,337, and 3,720,125.

Other systems for processing a beam or other workpiece may include apparatus having oxygen acetylene torches or high voltage plasma torches for cutting the workpiece to length or cutting a profile in the workpiece. Various processes may be combined in one machine, or in one processing line having a number of different machines in series.

Still other recent systems for processing a beam or other workpiece may include an industrial robot or multi-axis (e.g., 6-axis) robotic arm capable of maneuvering around the workpiece in three-dimensional space, the robot having one or more tools for processing the workpiece to perform processing on various surfaces of the workpiece.

There are several known methods for marking a workpiece. For example, an air scribing tool can be used to cut characters or layouts into the workpiece material. However, it has been found by the inventors that such air scribers can be slow, reducing machine throughput, and such air scribers may cut too deeply into the workpiece material. Other systems are known to employ a stylus that mechanically engraves characters or layouts in the workpiece material. However, this process has been found by the inventors to be unacceptably slow and may result in a less perceptible or visible marking. Some other methods use dot peen impacts on the workpiece material to effect markings, which can be slow, noisy, and results in less perceptible or visible markings. Still other methods employ lasers or ink jet printing on the workpiece surface, which has also been found to be either slow, susceptible to degradation or wear in typical environments encountered by the workpiece, or too expensive. Lasers in particular may be prohibitively expensive, and they may pose safety risks to operators of the processing machinery. Other methods utilize a standalone marking machine, which performs no other processing of the workpiece aside from marking. Standalone machinery will reduce throughput of the processing system and may increase the overall cost of the system.

Therefore, it would be desirable to decrease processing time of a workpiece by enhancing the workpiece marking process in a machine or system that performs other processing such as drilling or cutting.

It would be desirable to provide an improved system for processing a workpiece wherein the above-discussed problems could be eliminated, or at least substantially minimized.

It would further be desirable to provide an improved system for processing a workpiece wherein the need for a separate standalone marking machine is eliminated.

It would be especially beneficial if such an improved system could operate effectively with minimal maintenance in an environment that is dirty, and wherein drill chips and spray mist coolant might be thrown or dispersed around the workpiece.

It would also be desirable if such an improved system could be readily operated by an appropriate control system, could accommodate a variety of different types of workpieces (e.g., flat plates, channels, angles, H-beams, etc.), could produce accurate and repeatable results, and could relatively easily accommodate changes in the types and sizes of the workpieces being processed.

Also, it would be beneficial if such an improved system could employ components that are relatively small and that are relatively easy to fit in an existing processing machine or line.

It would further be beneficial if such an improved system could perform processing operations or jobs quickly and efficiently.

Further, it would be advantageous if the improved system could be manufactured, installed, and operated without incurring excessive costs or expenses.

### SUMMARY OF THE INVENTION

The present invention provides a novel, improved system and methods for processing a workpiece and that can accommodate designs having the above-discussed benefits and features.

According to one aspect of the invention, a system is disclosed for processing a workpiece. The system has a support surface for supporting a workpiece and defining a processing path along which a workpiece may travel relative to the system. The system has an automatic tool changer including at least a first tool storage bay for removably storing a drill tool therein and at least a second tool storage bay for removably storing a plasma torch tool therein. The system further has at least one drill spindle movable with respect to a surface of a workpiece. The drill spindle and the automatic tool changer are movable relative to one another and configured to facilitate the selective transfer between the drill spindle and the automatic tool changer of (i) a drill tool stored in the first tool storage bay for performing a drilling process on a workpiece, and (ii) a plasma torch tool stored in the second tool storage bay for performing a marking process on a surface of a workpiece.

In another form of the invention, the system is provided with a drill tool removably stored in the first tool storage bay of the automatic tool changer and a plasma torch tool removably stored in the second tool storage bay of the automatic tool changer. In one preferred form of the invention, the plasma torch tool includes a low voltage plasma marking torch that is only utilized for marking a surface of the workpiece. In another form of the invention, the plasma torch tool includes a high voltage plasma cutting torch that may be used for marking and/or cutting of the workpiece.

In still another form of the invention, the system defines a space having orthogonal X-Y-Z axes, whereby a surface of a workpiece resting on the support surface of the system resides generally within an X-Y plane (or at least in a plane parallel thereto). The drill spindle is configured to move in at least directions parallel to the Y-axis and directions normal to the surface of the workpiece. The automatic tool changer is movable relative to the drill spindle in at least a direction parallel to the X-axis.

According to another form of the present invention, the first and second tool storage bays of the automatic tool changer are substantially identical, whereby a drill tool may be removably stored in either of the first or second tool storage bays, and a plasma torch tool may be removably stored in either of the first or second tool storage bays. In one presently preferred form of the invention, the automatic tool changer includes at least three tool storage bays.

In yet another form of the present invention, the plasma torch tool has a proximal end configured for being releasably received in each of the drill spindle and the second tool storage bay. The drill tool has a proximal end and an operative, distal end, wherein the proximal end of the drill tool is configured for being releasably received in each of the drill spindle and the first tool storage bay. The proximal end of the drill tool and the proximal end of the plasma torch tool are substantially identical.

In one form of the present invention, the automatic tool changer is generally planar and has a plurality of tool storage bays which each include a pivotable opening facing toward the drill spindle.

According to still another form of the present invention, the system includes a plasma torch tool removably stored in the second tool storage bay of the automatic tool changer. The plasma torch tool including at least a base supporting a plasma torch defining a central axis and a pair of standoff posts located on opposite sides of the plasma torch relative to the central axis. Each one of the pair of standoff posts including a distal end for contacting a surface of a workpiece. The plasma torch tool further including a proximal end extending from the base which is configured for being received in each one of the drill spindle and the second tool storage bay of the automatic tool changer. In one preferred form of the invention, one of the pair of standoff posts includes a spring allowing a distal end of the post to be movable in a direction parallel to the central axis relative to the base. In still another preferred form of the invention, the base further includes a plasma torch gas valve mounted thereon and each one of the pair of standoff posts includes a roller bearing secured at its distal end for contacting a surface of the workpiece.

In one form of the present invention, the drill spindle and the automatic tool changer of the system includes: a first drill spindle and a first automatic tool changer located on a first lateral side (i.e., right side) of the processing path; a second drill spindle and a second automatic tool changer located on a second lateral side (i.e., left side) of the processing path; a third drill spindle and a third automatic tool changer located above the processing path.

According to another broad form of the invention, the system having at least one drill spindle and at least one automatic tool changer movable relative to the at least one drill spindle to facilitate the changing of a tool carried in the drill spindle, the system including a plasma torch tool including a proximal end configured to be received in each of the at least one automatic tool changer and the at least one drill spindle.

According to another broad form of the present invention, a plasma torch tool is disclosed for use in a system for processing a workpiece, the system of the type having a drill spindle and an automatic tool changer for changing a tool received in the drill spindle. The plasma torch tool includes a base and a plasma torch attached to, and extending outwardly from, the base and defines a central axis. The plasma torch tool further includes a pair of standoff posts attached to, and extending outwardly from, the base and located on opposite sides of the plasma torch relative to its central axis. Each one of the pair of standoff posts includes a distal end for contacting a surface of a workpiece. The plasma torch tool further includes a proximal end configured for being received in each of the drill spindle and an automatic tool changer (at separate times).

In still another form of the invention, a method of processing a workpiece is disclosed. The method includes the step of acquiring any of the systems discussed in the preceding paragraphs. The method further includes the step of loading a workpiece onto the support surface of the system. The method includes the step of loading a plasma torch tool from a automatic tool changer into a drill spindle and then performing a marking process on a surface of the workpiece with the plasma torch tool. In one preferred form of the invention, the method further includes the steps of unloading the plasma torch tool from the drill spindle into the automatic tool changer and loading a drill tool from the automatic tool changer into the drill spindle, and then performing a drilling process on a surface of the workpiece with the drill tool.

### BRIEF DESCRIPTION OF THE DRAWINGS

Numerous other advantages and features of the present invention will become readily apparent from the following detailed description of the invention, from the claims, and from the accompanying drawings.

In the accompanying drawings that form part of the specification, and in which like numerals are employed to designate like parts throughout the same,

FIG. 1 is an isometric view, taken from above, of a system according to the present invention for processing a workpiece (the workpiece not visible in FIG. 1);

FIG. 2 is a detail view of a portion of the system shown within the circled region labeled “FIG. 2” in FIG. 1;

FIG. 3 is a fragmentary, perspective view of a portion of the system of FIG. 1, and FIG. 3 shows two drill tools and a plasma torch tool retained in one of the automatic tool changers of the sy stem;

FIG. 4 is a fragmentary, perspective view of a portion of the system of FIG. 1, and FIG. 4 shows two drill tools removably in an automatic tool changer and a plasma torch tool loaded into a drill spindle for marking a workpiece surface;

FIG. 5 a fragmentary, perspective view of a portion of the system of FIG. 1, and FIG. 5 shows two drill tools and a plasma torch tool retained in an automatic tool changer and a drill tool loaded into a drill spindle for drilling into a workpiece surface;

FIG. 6 is an exploded, isometric view of one of the plasma torch tools of the system shown in FIG. 1, however in FIG. 6 does not show the electrical cables and gas tubing and protective shielding or guards of the plasma torch tool;

FIG. 7 is a fragmentary, side elevation view of one of the plasma torch tools of the system shown in FIG. 1, and FIG. 7 does not show all of the electrical cables and gas tubing of the plasma torch tool;

FIG. 8 is a fragmentary, front elevation view of the plasma torch tool shown in FIG. 7;

FIG. 9 is a cross-sectional view of a portion of the plasma torch tool shown in FIG. 7, taken along the plane 9-9 in FIG. 7; and

FIG. 10 is an isometric view, taken from above, of a plasma torch power unit, cable management assembly for the plasma power torch tool of FIG. 7, and FIG. 10 further shows a fragmentary portion of a workpiece in the form of a wide flange H-beam within the system for processing.

### DESCRIPTION OF THE PREFERRED EMBODIMENT

While this invention is susceptible of embodiment in many different forms, this specification and the accompanying drawings disclose only one specific form as an example of the use of the invention. The invention is not intended to be limited to the embodiment so described, and the scope of the invention will be pointed out in the appended claims.

For ease of description, the machine or system operating in accordance with this invention is described in the normal (upright) operating position, and terms such as above, below, left, right, etc., are used with reference to this position. It will be understood, however, that the system of this invention may be manufactured, stored, transported, used, and sold in an orientation other than that described.

The system operating in accordance with the process of this invention can have certain conventional components and control mechanisms the details of which, although not fully illustrated or described, will be apparent to those having skill in the art and an understanding of the necessary functions of such components and mechanisms.

Some of the Figures illustrating an embodiment of the processing system operating in accordance with the present invention show conventional structural details and mechanical elements that will be recognized by one skilled in the art. However, the detailed descriptions of such elements are not necessary to an understanding of the invention, and accordingly, are herein presented only to the degree necessary to facilitate an understanding of the novel features of the present invention.

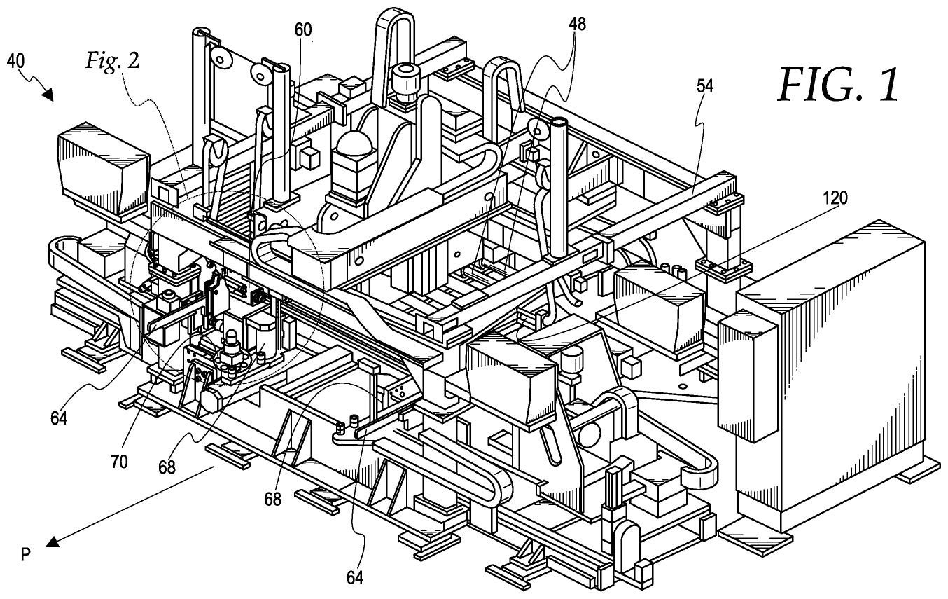

FIG. 1 shows a processing machine or system 40 according to the present invention for processing a structural steel beam that is generically referred to herein as a workpiece. For ease of illustration, some of the ancillary electrical wiring and gas hosing of the system 40 has been omitted. The system 40 includes a support surface 48 in the form of a roller conveyor defining a plurality of spaced-apart, parallel rollers and upon which a length of stock, such as a structural steel beam or other workpiece, can be initially positioned by a forklift, conveyor, transfer table, crane or other means.

The support surface 48 has an inlet end, an outlet end, and generally defines a processing path “P” between the inlet end and the outlet end for conveying the workpiece during processing. It will be understood that the support surface 48 may be any suitable conventional or special structure capable of supporting a workpiece (e.g., the roller type conveyer as illustrated, a belt conveyor, a non-movable surface, etc.) and the support surface may be driven by any conventional or special means, such as by an electric motor, hydraulics, pneumatics, engine, etc.

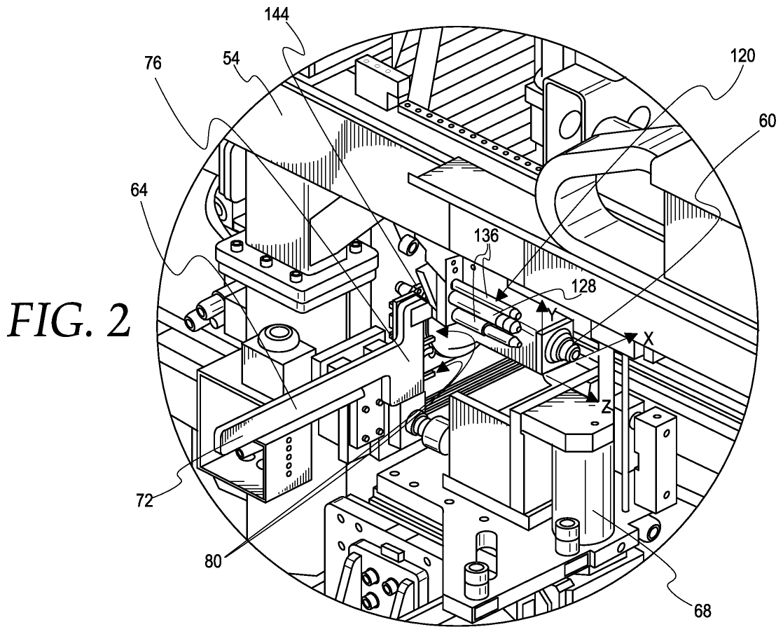

Referring to FIG. 1, the system 40 includes a frame 54 extending laterally on either side of, and above, the support surface 48. As will be discussed in greater detail hereinafter, the frame 54 supports a number of drill spindles 60 (FIG. 2) for processing (e.g., drilling, milling, cutting, and/or marking) a workpiece, and a number of automatic tool changers 64 (FIG. 2) for holding or storing various tools to be utilized by the spindles 60. While the particular embodiment of the system 40 illustrated has three drill spindles 60, with one drill spindle 60 arranged on the left side of the processing path “P” of the support surface 48, one drill spindle 60 arranged on a right side of the of the processing path “P” of the support surface 48, and one drill spindle 60 arranged above the support surface 48, it will be understood that the system 40 may have one or more drill spindles 60 and one or more automatic tool changers 64 for each spindle 60. The drill spindles 60 may utilize a 25 HP/18.5 kW smart spindle motor manufactured by Siemens having offices at Wittelsbacherplatz 2, Munich, Germany 80333. Other special or conventional drill spindle motors may be used. Each of the drill spindles 60 is movable via an electronically powered lead screw along one axis, while the drill motor itself may move normal relative to the workpiece surface. Other means of movement may be used such as hydraulics, pneumatics, gears, solenoids, etc., to move the drill spindles 60 relative to the workpiece surface along at least one axis. In some applications, the drill spindles 60 may have additional degrees of freedom of movement relative to the workpiece surface. Each of the automatic tool changers 64 is hydraulically movable linearly along one axis toward and away from its respective drill spindle 60 to facilitate the transfer of a tool between the nearest spindle 60 and then move out of the way of the spindle 60 for subsequent processing of the workpiece. Other means may be used such as an electronically powered lead screw, pneumatics, gears, solenoids, etc. to move the automatic tool changers 64 relative to their respective drill spindle 60. In some applications (not illustrated), the automatic tool changers 64 may have additional degrees of freedom of movement, or may be stationary relative to the drill spindles 60, which of course would require additional degrees of freedom of movement.

Referring to FIGS. 1 and 2, the frame 54 is provided with a hydraulically actuated roller feed system or clamp assembly 68 for holding a workpiece at a fixed location along a datum line with respect to the frame 54 and also for indexing or feeding the workpiece forward and rearward along the processing path “P” as needed. The clamp assembly 68 includes a stationary first clamping surface and a movable second clamping surface that is hydraulically movable toward the first clamping surface. Specifically, the second clamping surface is movable laterally in a direction that is generally perpendicular or normal to the processing path “P” (FIG. 1). The first and second clamping surfaces have the form of a vertical rollers that is connected to frame 54 on the left and right sides of the processing path “P”. With a workpiece clamped between the first and second clamping surfaces or rollers, a measuring wheel or encoder wheel 70 (FIG. 1) of the system 40 makes rolling contact against a surface of the workpiece to precisely measure the length of the workpiece against the datum while moving the workpiece forward or rearward along the processing path “P” atop the support surface 48. The encoder wheel 70 may be comprised of a spring-loaded wheel and a rotational encoder sensor. The spring loading of the encoder wheel ensures that the encoder wheel stays in constant contact with a surface of a workpiece.

The system 40 may include any number of means for precisely locating a workpiece within the system 40 and may have one or more laser switches or sensors and associated reflectors configured to detect the location of a leading end and/or trailing end of the workpiece as it moves into, through, and out of the system 40.

With reference to FIG. 2, if the workpiece surface resides generally within an X-Y plane (or in a plane parallel thereto), with the Z-axis extending normal to the X-Y surface, in the illustrated preferred embodiment of the system 40 each of the drill spindles 60 can move along one axis (e.g., along the Y-axis for the drill spindles 60 located on the left and right side of the processing path “P”), and the drill spindles 60 may also move toward and away from the surface of the workpiece along the Z-axis to perform a drilling or other processing action on the surface of the workpiece. It will be understood that the drill spindles 60 could have a greater or lesser number of degrees freedom of motion relative to the workpiece, and the workpiece may alternatively be movable relative to the drill spindles 60.

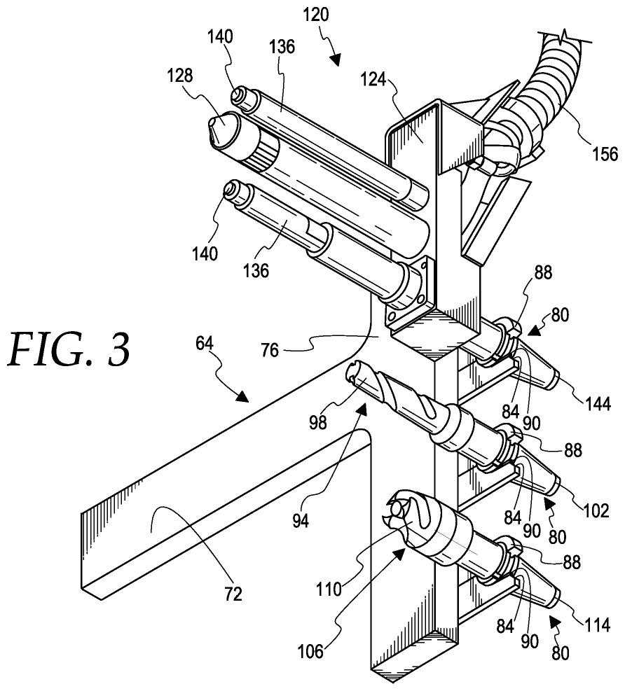

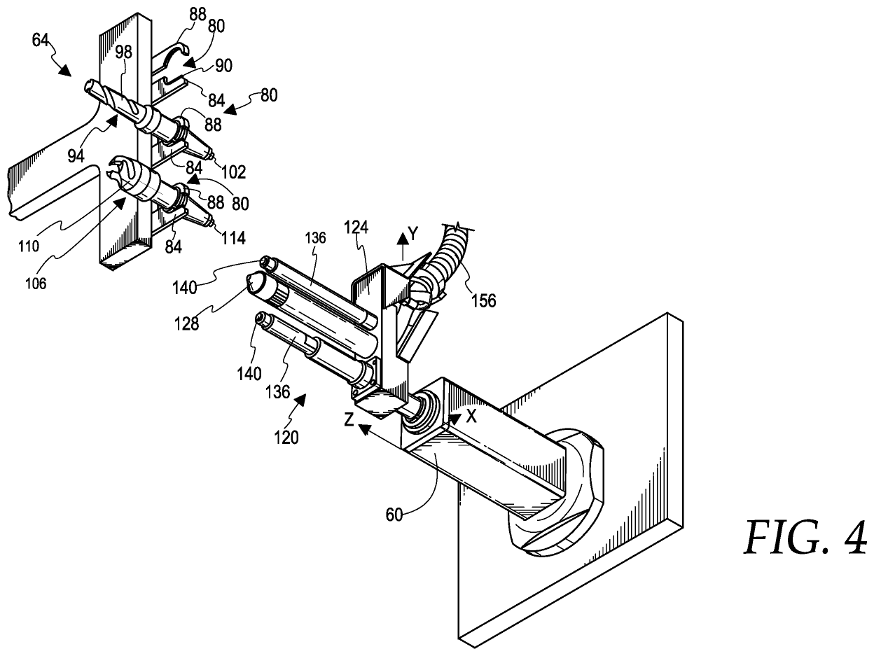

Each automatic tool changer 64 is movable along at least one axis relative to its respective drill spindle 60. With reference to FIG. 2, which shows the drill spindle 60 and the automatic tool changer 64 which are located on a right side of a processing path “P”, the automatic tool changer 64 is slidable along (or parallel to) the X-axis toward and away from the drill spindle 60. In this manner, the automatic tool changer 64 may reside outside of the work area for the drill spindle 60, and selectively move into the work area to present one or more tools for selection by the drill spindle 60 to change a tool (e.g., drill tool containing a drill bit or a plasma torch tool containing a marking and/or cutting plasma torch) that is held within the drill spindle 60, and then slide back outside of the work area, as will be discussed in greater detail below. The automatic tool changer 64 is somewhat planar and T-shaped, and it includes an elongate distal end 72 connected to the actuator mechanism (drive screw or hydraulic piston, etc.) and a relatively wider proximal end 76. The proximal end 76 includes a plurality tool holders or tool storage bays 80 for holding a number of tools for use in the drill spindle 60. Referring now to FIGS. 3-5, the tool storage bays 80 each have a C-shape configuration with an open end defined by a first member 84 (FIG. 4) that is fixed to the proximal end 76 and a second member 88 (FIG. 4) that is pivotably connected to the proximal end 76 and which pivots relative to the first member 84. As will be discussed in greater detail herein, each of the first and second members 84 and 88, includes a projection or tongue 90 (FIG. 3) for being received within a groove or channel in a shank or proximal portion of a given tool.

In one preferred embodiment of the inventive system 40, the system 40 utilizes automatic tool changers 64 such as those utilized in the PCD-1100/3C—ADVANTAGE-2 DRILL LINE manufactured by Peddinghaus Corporation having facilities at 300 North Washington Avenue, Bradley, Ill. 60915, USA. While the illustrated preferred embodiment of the invention utilizes automatic tool changers 64 with tool storage bays 80 that are configured to receive ANSI/ASME B5.50 CAT 40 type proximal ends, shanks or drill spindle interfaces, it will be understood that the tool storage bays 80 could be modified to accommodate HSK, BT, CAPTO or other commercially available interfaces.

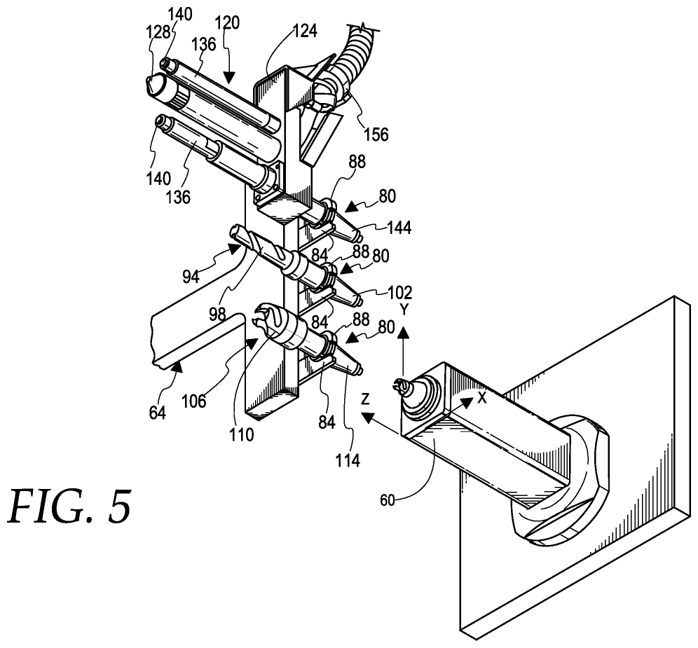

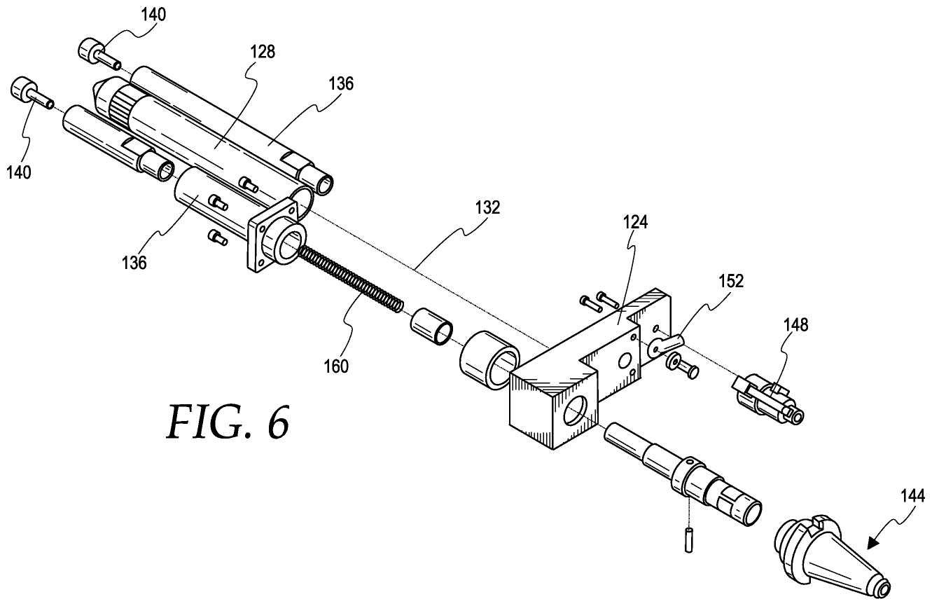

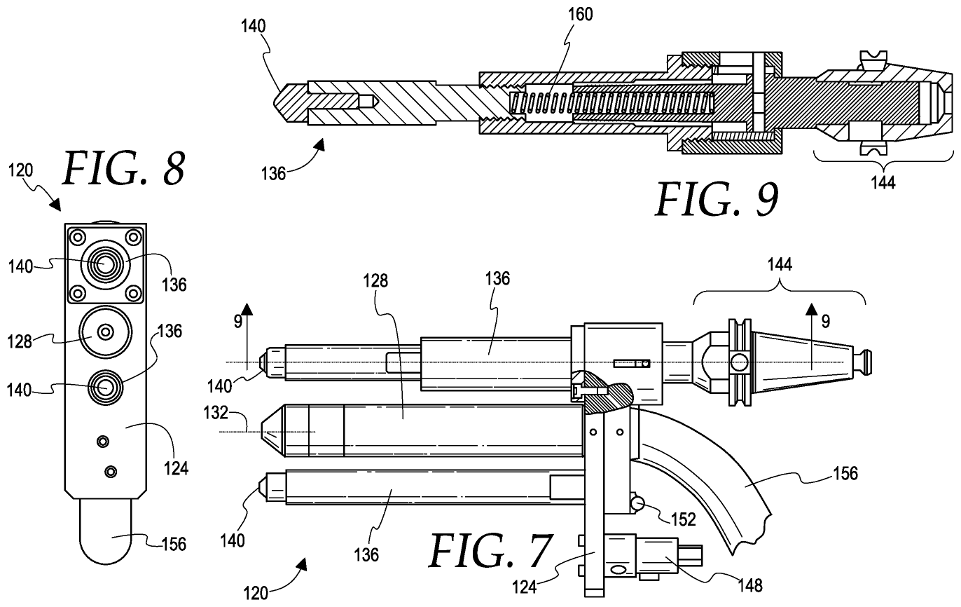

The system 40 may be provided with a number of drill tools for use in the drill spindles 60. For example, with reference to FIGS. 3 and 5, a first drill tool 94 having an operative, distal end or drill bit 98 and a proximal end or shank portion 102 is received in one of the tool storage bays 80 of the automatic tool changer 64. It can further be seen that a second drill tool 106 having an operative, distal end or drill bit 110 and a proximal end or shank portion 114 is received in another tool storage bay 80 of the same automatic tool changer 64. The shank portions or proximal ends 102 and 114 of the drill tools 94 and 106 are ANSI/ASME B5.50 CAT 40 type shanks or drill spindle interfaces. However, it will be understood that the drill tool proximal ends 102 and 114 could be HSK, BT, CAPTO or other commercially available shanks or drill spindle interfaces and that the tool storage bays 80 would be modified to mate with, and releasably retain, these other types of interfaces.

With reference now to FIGS. 3 and 7, a plasma torch tool 120 is provided in each of the automatic tool changers 64 for being received within, and utilized by, their respective drill spindle 60. The plasma torch tool 120 includes a body or base 124, a plasma torch 128 supported on a first side of the base 124 defining a central axis 132, a pair of standoff posts 136 supported on the first side of the base 124 and located above and below the central axis 132 of the plasma torch 128. Each of the standoff posts 136 includes a distal end 140 for contacting a surface of a workpiece. The plasma torch tool 120 includes a proximal end 144 extending from an opposite side of the base 124 relative to the plasma torch 128, which is configured to be received in a tool storage bay 80 and in a drill spindle 60. A gas valve 148 and a ground cable attachment 152 are secured to the base 124 on the second side of the base 124. For ease of illustration, some of the ancillary electrical wiring and gas hosing of the plasma torch tool 120 has been omitted, with only a fragmentary portion of the cables 156 (including the gas and electrical connections) being illustrated in FIG. 7. The function of some of the minor components of the plasma torch tool 120, such as bearings, screws, bushings, pins, washers, valves, etc., while not described in detail, will be understood by one of ordinary skill in the art. As discussed above, while the illustrated preferred embodiment of the invention utilizes automatic tool changers 64 with tool storage bays 80 that are configured to receive ANSI/ASME B5.50 CAT 40 type shanks or drill spindle interfaces, such as the proximal end 144 of the plasma torch tool 120, it will be understood that the proximal end 144 could be modified to be a HSK, BT, CAPTO or other commercially available shanks or drill spindle interfaces.

The particular plasma torch 128 that is illustrated is an ArcWriter low power plasma marking torch manufactured by Hypertherm, Inc. having facilities at 21 Great Hollow Road, Hanover, N.H. 03755, USA. It will be understood that in some applications other conventional or special plasma torches could be used in the plasma torch tool 120, such as a high voltage plasma cutting torch for cutting or severing a portion of a workpiece.

Still referring to FIGS. 3 and 7, each standoff post distal end 140 includes a roller bearing for rolling and/or sliding against the surface of a workpiece to establish a nominal 2.0 mm offset of the nozzle end of the plasma torch 128 from the surface of the workpiece for nominal performance. One of the two standoff posts 136 includes a reciprocating mechanism whereby its distal end 140 is biased by a compression spring 160 relative to the base 124. The total travel of the spring 160 is preferably about 20 mm to accommodate material deviations of about +/−10 mm in either direction along the central axis 132 of the plasma torch 128. In some applications, the plasma torch tool 120 may be provided with just one standoff post 136, or with more than two standoff posts 136. In some applications the posts 136 need not have the form of a post at all. In yet other applications, not illustrated, the standoff posts 136 may be omitted altogether.

While in the preferred embodiment of the invention the plasma torch tool 120 includes a plasma torch 128 for marking of one or more surfaces of a workpiece, in other applications (not illustrated), other types of tools may be used, such as a laser marking tool with appropriate shielding for operator safety, a milling tool, a tapping tool, countersinking tool, or even an oxygen acetylene torch in the tool 120. For example, an MT5 oxygen acetylene torch manufactured by Victor Equipment having facilities at 2800 Airport Road, Denton, Tex. 76207, USA could be used in place of the plasma torch 128.

In addition, while the drill spindles 60 of the illustrated preferred embodiment of the invention move along only a single axis relative to the workpiece surface, the drill spindles 60 may have a greater number of degrees of freedom. For example, any of the drill spindles 60 may be carried at the operative end of a multi-axis (e.g., six axis) robot arm or industrial robot having plurality of independently movable members, each rotatable about an axis by an electric motor. The distal-most movable member terminating in an end effector for receiving any one of a plasma marking torch, plasma marking torch, oxygen acetylene torch, milling tool, etc. The industrial robot may be any suitable conventional or special multi-axis or industrial robot, such as those manufactured by Kuka AG, FANUC, DENSO, and others. Basic design and control of such robots are described generally in U.S. Pat. Nos. 5,550,953 and 8,367,970, each of which is incorporated by reference in its entirety. However, it will be understood that the illustrated preferred embodiment may more quickly perform a marking process on a workpiece surface, including multiple processes on multiple surfaces at the same time, for a much lower cost than a conventional multi-axis robot arm or arms.

The control application for the system 40 preferably is, or includes, a single software program that controls all operational aspects of the system 40 including the programmable logic controller system, the roller feed system for moving the workpiece along the processing path “P”, the drill spindles 60, the automatic tool changers 64, and the gas and electric system for the plasma torch 128. However, it will be understood that the that the control application may be split into any number of programs or applications running on a control terminal or any other local or remote computer.

The inventors have found that providing the system 40 as described above, with at least one plasma torch tool 120 including a plasma marking torch 128 for being stored in an automatic tool changer 64 and utilized in a drill spindle 60, can address a number of common problems with prior art processing systems. Such a plasma torch tool 120 may perform marking and/or cutting operations to greatly enhance the usefulness and processing speed of a workpiece or material through the system 40 having at least one drill spindle 60. Providing a plasma torch tool 120 for use in a drill spindle 60 may further advantageously greatly reduce costs for layout marking compared to other prior art systems that require either separate marking machinery or mechanical, air, or laser scribing machinery. Specifically, the drill spindle 60 equipped with the plasma torch tool 120, which moves along one orthogonal axis relative to the workpiece surface, may work together with the feed rollers that feed the workpiece forward or rearward along the processing path “P” to piece together lines to mark out characters, outlines for mating parts, or other features without necessitating a relatively more expensive multi-axis robot or layout marking machinery.

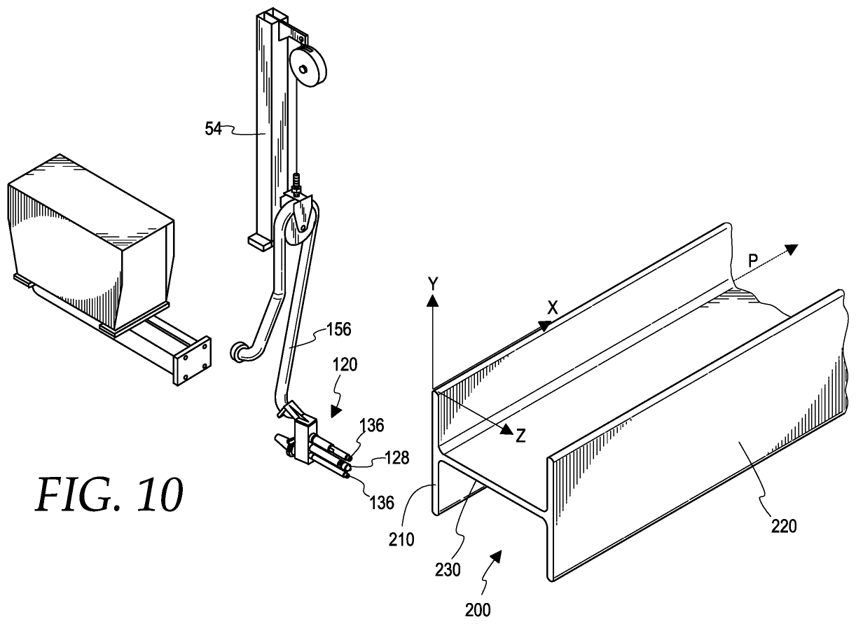

According to one way of operating the system 40, an operator of the system 40 will use the software application running on a control terminal (not visible in FIG. 1) for the system 40 to start a processing job. The parameters of the processing job can be determined in the application by the operator, or more preferably, can be created in the application by loading an existing CAD/CAM file (or any other virtual representation of the workpiece and the features to be cut or marked into the workpiece) for the particular workpiece to be processed. When the CAD/CAM file is loaded, a graphical representation of the workpiece may be displayed by the application. The PLC system or application is then provided with the basic information of the workpiece, such as shape (e.g., H-beam, I-beam, L-beam, channel, etc.), size, thickness, length, etc. The PLC application uses this information to prepare the system 40 for the particular workpiece. For the example discussed herein, an H-beam (a lead portion of which is designated as numeral 200 in FIG. 10) is loaded onto the support surface 48 resting on both flanges such that a top flange 210 is located on a right side of the processing path “P”, a bottom flange 220 is located on a left side of the processing path “P”, and a central web 230 extends between the flanges 210, 220. Furthermore, the PLC application controls the loading position of the H-beam workpiece 200 and hydraulic pressure for the clamp assembly 68. Hydraulic pressures are determined based on the workpiece material thickness and shape. The illustrated preferred embodiment of the system 40 includes at least a drill spindle 60 on the right side of the of the processing path “P” for processing the top flange 210, a drill spindle 60 on the left side of the of the processing path “P” for processing the bottom flange 220, and a drill spindle 60 above the of the processing path “P” for processing the web 230. Each of the drill spindles 60 includes at least one automatic tool changer 64 that moves in an orthogonal direction toward and away from its respective spindle 60.

In this example, only the drill spindle 60 and automatic tool changer 64 for the top flange 210 will be discussed. It will be understood that the other drill spindles 60 and tool changers 64 would operate in a similar manner. Referring now to FIG. 10, with the H-beam workpiece 200 clamped in system, its length generally extends along the processing path “P”. The top flange 210 of the workpiece 200 has a surface generally residing in an X-Y plane (FIG. 10) (or at least in a plane that is parallel thereto) with the X-axis extending parallel to the processing path “P” and a Z-axis extending normal to the X-Y plane toward the bottom flange 220 along the web 230. The drill spindle 60 is capable of moving in directions parallel to the Y-axis and the Z-axis, while the clamp assembly 68 can index the H-beam workpiece 200 in directions parallel to the X-axis along the path “P”.

With reference to FIGS. 2 and 5, the automatic tool changer 64 is movable in directions parallel to the X-axis toward and away from the drill spindle 60 in order to change the tool utilized by the drill spindle 60 for a particular process. For example, with reference to FIG. 4, where it is shown that the plasma torch tool 120 is loaded in a drill spindle 60, the drill spindle 60 may move along the Y-axis until it is aligned along the X-axis with a vacant and top-most tool storage bay 80 in the automatic tool changer 64. The automatic tool changer 64 will then move along the X-axis toward the spindle 60 such that the second member 88 of the tool storage baby 80 pivots relative to the first member 84 to close around a proximal end 144 or shank of the plasma torch tool 120. With the proximal end 144 or shank of the plasma torch tool 120 secured in the tool storage bay 80, the spindle 60 may then retract along the Z-axis to completely separate from the proximal end 144 or shank of the plasma torch tool 120.

With reference to FIGS. 3 and 5, the drill spindle 60 may then move may move along the Y-axis until it is aligned with a different tool storage bay 80 in the automatic tool changer 64, such as one occupied by a drill tool 94. The spindle 60 may then extend along the Z-axis to receive and secure the proximal end 102 of the drill tool 94. The automatic tool changer 64 will then move along the X-axis away from the spindle 60 such that the second member 88 of the tool storage baby 80 pivots relative to the first member 84 to open up from around a proximal end 102 or shank of the drill tool 94 to leave the processing area of the spindle 60 (such as shown in FIG. 5).

Referring back to FIG. 4, when the plasma torch tool 120 is received within the drill spindle 60 for a marking application on the top flange 210 (visible in FIG. 10 only), the cables 156 including the gas and electrical lines are routed advantageously above and away from the drill spindle 60. In this orientation, the standoff posts 136 reside generally above and below the plasma marking torch 128 along the Y-axis, with the reciprocating standoff post 136 including the spring 160 located beneath the plasma marking torch 128. The reciprocating standoff post 136 permits the plasma torch 128 to remain at the nominal spacing in the Z-axis direction from the surface of the top flange 210 even with material deviations of the workpiece, rust on the surface of the top flange 210, etc. The drill spindle 60 equipped with the plasma torch tool 120, which moves up or down along the Y-axis (or parallel thereto) relative to the surface of the top flange 210, may work together with the clamp assembly 68 that feeds the workpiece 200 forward or rearward along the processing path “P” to create lines to mark out characters, outlines for mating parts, etc. on the surface of the top flange 210 in the X-Y plane (or plane parallel thereto).

The spindle 60, described above, can work in the same manner with other tools, such as a drill, plasma marking torch, etc. for creating various features in the H-beam workpiece 200 (e.g., bolt holes, cut profiles, milling, etc.). During operation of the system 40, the application builds a process tree for each sequential process (e.g., cutting, drilling, coping, marking, etc.) to be performed on the workpiece 200 to create these features. The operator may manually adjust, in the application, the particular processing tool to be used and/or disable one or more processes from being performed.

After the operator is finished preparing the process job in the application, and after the workpiece 200 has been positioned on the support surface 48 and clamping assembly 68, the processing job is started by initializing the PLC system when the operator presses a physical start button. The front end or portion of the workpiece 200 is conveyed forward along the processing path “P” until the workpiece 200 front end is detected (such as by a laser light or mechanical switch), and the workpiece 200 is driven further forwardly by the PLC system a predetermined distance based on the size, shape, and length of the workpiece 200. Specifically, the rolling surfaces of the clamping assembly 68 are hydraulically driven against the top flange 210 and 220 forcing the top flange 210 against a datum. With the top flange 210 located against the datum an encoder wheel 70 makes rolling contact with the top flange 210. With the encoder wheel 70 in contact with the workpiece 200, the workpiece 200 is moved further forwardly by the clamp assembly 68 until a sufficient leading length of the workpiece 200 is extended or cantilevered into the processing volume or area proximal the spindles 60 to accommodate the desired (i.e., programmed) processing (i.e., cutting, marking, drilling, etc.) at a first location of a feature (e.g., bolt hole, profile, layout marking) rearwardly from the leading end of the workpiece 200.

The application then generates and sends motion instructions for the spindles 60 and the clamping assembly 68 to create features in the workpiece surfaces (top flange 210, bottom flange 220, and/or web 230). In an example of operation, system 40 may receive instructions for cutting the first of a plurality of bolt holes in the top flange 210, bottom flange 220, and web 230 of the workpiece 200, and further receive instructions for layout marking on the top flange 210. The three spindles 60 will retrieve the appropriately sized drill tool from their respective automatic tool changer 64, and then proceed to drill holes along the length of the workpiece 200 in coordination with the clamp assembly 68. The spindle 60 on the right side of the processing path “P” would then deposit the drill tool in an open tool storage bay 80 and retrieve the plasma torch tool 120, as described in detail above, and then proceed to make the required marking on the top flange 210. Once the job or task of cutting the bolt holes is completed, the system 40 may be given additional features to create, such as layout marking of the web 230 of the workpiece 200.

Small scrap material that is removed from the workpiece 200 falls beneath the system 40 and may be conveyed away system 40 or otherwise removed.

Following the processing of the trailing end of the workpiece 200, the workpiece 200 is then removed from the outlet of the system 40 such as by being conveyed onto a mating conveyor, lifted by a forklift or crane, etc. (not illustrated).

It will be readily apparent from the foregoing detailed description of the invention and from the illustrations thereof that numerous variations and modifications may be effected without departing from the true spirit and scope of the novel concepts or principles of this invention.

1. A system for processing a workpiece, said system comprising:
(A) a support surface for supporting a workpiece, said support surface defining a processing path along which a workpiece may travel relative to said system;
(B) an automatic tool changer having
(1) a first tool storage bay for removably storing a drill tool therein;
(2) a second tool storage bay for removably storing a plasma torch tool therein; and
(C) at least one drill spindle movable with respect to a surface of a workpiece, said drill spindle and said automatic tool changer movable relative to one another and configured to facilitate the selective transfer between said drill spindle and said automatic tool changer of
(i) a drill tool stored in said first tool storage bay, said drill tool for performing a drilling process on a workpiece, and
(ii) a plasma torch tool stored in said second tool storage bay, said plasma torch tool for performing a marking process on a surface of a workpiece.

2. The system in accordance with claim 1 further comprising a drill tool removably stored in said first tool storage bay of said automatic tool changer, and a plasma torch tool removably stored in said second tool storage bay of said automatic tool changer.

3. The system in accordance with claim 2 in which said plasma torch tool includes a low voltage plasma marking torch.

4. The system in accordance with claim 2 in which said plasma torch tool includes a high voltage plasma cutting torch.

5. The system in accordance with claim 1 defining a space having orthogonal X-Y-Z axes, a surface of a workpiece resting on said support surface resides generally within an X-Y plane, said drill spindle is movable in at least directions parallel to the Y-axis and normal to the surface of the workpiece, and said automatic tool changer is movable relative to said drill spindle in at least a direction parallel to the X-axis.

6. The system in accordance with claim 1 in which said first and second tool storage bays are substantially identical, whereby a drill tool may be removably stored in either of said first or second tool storage bays, and a plasma torch tool may be removably stored in either of said first or second tool storage bays.

7. The system in accordance with claim 1 in which said automatic tool changer includes at least three tool storage bays.

8. The system in accordance with claim 2 in which said plasma torch tool has a proximal end configured for being releasably received in each of said drill spindle and said second tool storage bay, and said drill tool has a proximal end and an operative, distal end, said proximal end of said drill tool configured for being releasably received in each of said drill spindle and said first tool storage bay, wherein said proximal end of said drill tool and said proximal end of said plasma torch tool are substantially identical.

9. The system in accordance with claim 1 wherein said automatic tool changer is generally T-shaped and includes an elongate distal end connected to an actuator mechanism and a relatively wider proximal end having a plurality of tool storage bays each opening toward said drill spindle.

10. The system in accordance with claim 1 further comprising a plasma torch tool removably stored in said second tool storage bay of said automatic tool changer, said plasma torch tool comprising:
(A) a base;
(B) a plasma torch supported on said base, said plasma torch defining a central axis;
(C) a pair of standoff posts supported on said base and located on opposite sides of said plasma torch relative to said central axis, each one of said pair of standoff posts including a distal end for contacting a surface of a workpiece,
(D) a proximal end configured for being received in each of said drill spindle and said second tool storage bay of said automatic tool changer.

11. The system in accordance with claim 10 wherein one of said pair of standoff posts includes a spring and is movable in a direction parallel to said central axis relative to said base.

12. The system in accordance with claim 10 wherein said base further includes a plasma torch gas valve mounted thereon.

13. The system in accordance with claim 10 wherein each one of said pair of standoff posts includes a roller bearing secured at said distal end.

14. The system in accordance with claim 1 wherein said drill spindle and said automatic tool changer have the form of: a first drill spindle and a first automatic tool changer located on a first lateral side of said processing path, a second drill spindle and a second automatic tool changer located on a second lateral side of said processing path, a third drill spindle and a third automatic tool changer located above said processing path.

15. A system for processing a workpiece, said system having at least one drill spindle and at least one automatic tool changer movable relative to said at least one drill spindle to facilitate the changing of a tool carried in said drill spindle, said system comprising:
a plasma torch tool including a proximal end configured to be received in each of said at least one automatic tool changer and said at least one drill spindle.

16. A plasma torch tool for use in a system for processing a workpiece, the system of the type having a drill spindle and an automatic tool changer for changing a tool received in the drill spindle, said plasma torch tool comprising:
(A) a base;
(B) a plasma torch supported on said base, said plasma torch defining a central axis;
(C) a pair of standoff posts supported on said base and located on opposite sides of said plasma torch relative to said central axis, each one of said pair of standoff posts including a distal end for contacting a surface of a workpiece; and
(D) a proximal end configured for being received in a drill spindle and an automatic tool changer.

17. A method for processing a workpiece, said method comprising the steps of:
(A) acquiring the system of claim 2;
(B) loading a workpiece onto said support surface;
(C) loading said plasma torch tool from said automatic tool changer into said drill spindle; and
(D) performing a marking process on a surface of said workpiece with said plasma torch tool.

18. The method in accordance with claim 17 further comprising the steps of:
(E) unloading said plasma torch tool from said drill spindle into said automatic tool changer;
(F) loading said drill tool from said automatic tool changer into said drill spindle; and
(G) performing a drilling process on a surface of said workpiece with said drill tool.

19.-36. (canceled)
